(19) United States
(12) Patent Application Publication
(10) Pub. No.: US 2011/0051935 A1
(43) Pub. Date: Mar. 3, 2011

(54) METHOD AND APPARATUS FOR ENCODING AND DECODING STEREO AUDIO

(75) Inventors: Han-gil MOON, Seoul (KR); Chul-woo LEE, Anyang-si (KR)

(73) Assignee: SAMSUNG ELECTRONICS CO., LTD., Suwon-si (KR)

(21) Appl. No.: 12/868,248

(22) Filed: Aug. 25, 2010

(30) Foreign Application Priority Data
Aug. 27, 2009 (KR) 10-2009-0079773

(51) Int. Cl. H04R 5/00

(52) U.S. Cl. 381/1

(57) ABSTRACT

A method of encoding stereo audio that minimizes a number of pieces of side information required for parametric-encoding and parametric-decoding of the stereo audio. The side information may include parameters about interchannel intensity difference (IID), interchannel correlation (IC), overall phase difference (OPD), and interchannel phase difference (IPD), which are required to restore the mono audio to the stereo audio.

### CROSS-REFERENCE TO RELATED PATENT APPLICATION

This application claims priority from Korean Patent Application No. 10-2009-0079773, filed on Aug. 27, 2009, in the Korean Intellectual Property Office, the disclosure of which is incorporated herein by reference in its entirety.

### BACKGROUND OF THE INVENTION

1. Field of the Invention

The present invention relates to a method and apparatus for encoding and decoding stereo audio, and more particularly, to a method and apparatus for parametric-encoding and parametric-decoding stereo audio by minimizing the number of pieces of side information required for parametric-encoding and parametric-decoding the stereo audio.

2. Description of the Related Art

Generally, methods of encoding multi-channel (MC) audio include waveform audio coding and parametric audio coding. Examples of the waveform audio coding include moving picture experts group (MPEG)-2 MC audio coding, advanced audio coding (AAC) MC audio coding, and bit sliced arithmetic coding (BSAC)/audio video coding standard (AVS) MC audio coding.

In the parametric audio coding, an audio signal is encoded by analyzing a component of the audio signal, such as a frequency or amplitude, and parameterizing information about the component. When stereo audio is encoded by using the parametric audio coding, mono audio is generated by down-mixing right channel audio and left channel audio, and then the generated mono audio is encoded. Then, parameters about interchannel intensity difference (IID), interchannel correlation (IC), overall phase difference (OPD), and interchannel phase difference (IPD), which are required to restore the mono audio to the stereo audio, are encoded. Here, the parameters may also be called side information.

The parameters about IID and IC are encoded as information for determining the intensities of the left channel audio and the right channel audio, and the parameters about OPD and IPD are encoded as information for determining the phases of the left channel audio and the right channel audio.

### SUMMARY OF THE INVENTION

The present invention provides a method and apparatus for parametric-encoding and parametric-decoding stereo audio by minimizing the number of pieces of side information required for performing parametric-encoding and parametric-decoding the stereo audio.

According to an aspect of the present invention, there is provided a method of encoding audio, the method including: generating a first beginning divided audio signal and a second beginning divided audio signal from a beginning mono audio signal, the beginning mono audio signal generated from first and second center input audio signals located in the center of received N input audio signals; generating a first final divided audio signal and a second final divided audio signal by adding remaining input audio signals, among the N input audio signals other than the first and second center input audio signals, to each of the first and second beginning divided audio signals, and generating a final mono audio signal by adding the first and second final divided audio signals; generating side information for restoring each of the N input audio signals, the first and second beginning divided audio signals, the first and second final divided audio signals, and transient divided audio signals, the transient divided audio signals generated from the remaining input audio signals; and encoding the final mono audio signal and the side information.

The method may further include: encoding the N input audio signals; decoding the encoded N input audio signals; and generating information about differences between the decoded N input audio signals and the received N input audio signals, wherein, in the encoding of the final mono audio signal and the side information, the information about the differences is encoded.

The encoding of the side information may include: encoding information for determining intensities of the first and second center input audio signals, the remaining input audio signals, the first and second beginning divided audio signals, the transient divided audio signals, and the first and second final divided audio signals; and encoding information about phase differences between the first and second center input audio signals in the first and second center input audio signals, the remaining input audio signals, the first and second beginning divided audio signals, the transient divided audio signals, and the first and second final divided audio signals.

The encoding of the information for determining intensities may include: generating a vector space in which a first vector and a second vector form a predetermined angle, wherein the first vector represents an intensity the first center input audio signal, and the second vector represents an intensity of the second center input audio signal; generating a third vector by adding the first vector and the second vector in the vector space; and encoding at least one of information about an angle between the third vector and the first vector, and information about an angle between the third vector and the second vector, in the vector space.

The encoding of the information for determining intensities may comprise encoding at least one of information for determining an intensity of the first beginning divided audio signal and information for determining an intensity of the second beginning divided audio signal.

According to another aspect of the present invention, there is provided a method of decoding audio, the method including: extracting an encoded mono audio signal and encoded side information from received audio data; decoding the extracted mono audio signal and the extracted side information; restoring first and second beginning restored audio signals from the decoded mono audio signal, and generating N−2 final restored audio signals from transient restored audio signals by decoding the first and second beginning restored audio signals, based on the decoded side information; and generating a combination restored audio signal by adding the transient restored audio signals that are generated last from among the transient restored audio signals, and generating first and second final restored audio signals from the combination restored audio signal based on the decoded side information.

The method may further include extracting information about differences between N decoded audio signals and N original audio signals in the received audio data, wherein the N decoded audio signals may be generated by encoding and decoding the N original audio signals, wherein the first and second final restored audio signals may be generated based on the decoded side information and the information about the differences.

The decoded side information may include: information for determining intensities of the first and second beginning restored audio signals, the transient restored audio signals, and the first and second final restored audio signals; and information about phase differences between the first and second final restored audio signals restored from the first and second beginning restored audio signals, the transient restored audio signals, and first and second the final restored audio signals.

The method of claim 8, wherein the information for determining the intensities comprises information about an angle between a first vector and a third vector or between a second vector and the third vector in a vector space generated in such a way that the first vector and the second vector form a predetermined angle, wherein the first vector is about intensity of one of two following restored audio signals of each of the beginning restored audio signals, the transient restored audio signals, and the final restored audio signals, the second vector is about intensity of the other of the two following restored audio signals, and the third vector is generated by adding the first and second vectors.

The restoring of the first and second beginning restored audio signals may include: determining an intensity of at least one of the first beginning restored audio signal and the second beginning restored audio signal, by using at least one of the angle between the first vector and the third vector and the angle between the second vector and the third vector; calculating a phase of the first beginning restored audio signal and a phase of the second beginning restored audio signal based on information about a phase of the decoded mono audio signal and information about a phase difference between the first beginning restored audio signal and the second beginning restored audio signal; and restoring the first and second beginning restored audio signals based on the information about the phase of the decoded mono audio signal, the information about the phase of the second beginning restored audio signal, and the information for determining the intensities of the first and second beginning restored audio signals.

When a first final transient restored audio signal from among the final transient restored audio signals and the first final restored audio signal are restored from a J−1^{th} transient restored audio signal, and the second final restored audio signal and a second final transient restored audio signal having an intensity that is the same as an intensity and a phase that is the same phase as the first final transient restored audio signal is restored from a J^{th} transient restored audio signal, the second final restored audio signal may be restored by subtracting the first final transient restored audio signal from the J^{th} transient restored audio signal, when the first final transient restored audio signal is restored based on information about a phase of the J−1^{th} transient restored audio signal, the information about a phase difference between the first final restored audio signal and the first final transient restored audio signal, and information for determining the intensity of the first final transient restored audio signal.

According to another aspect of the present invention, there is provided an apparatus for encoding audio, the apparatus including: a mono audio generator that generates a first beginning divided audio signal and a second beginning divided audio signal from a beginning mono audio signal, the beginning mono audio signal generated from first and second center input audio signals located in the center of received N input audio signals, generates a first final divided audio signal and a second final divided audio signal by adding remaining input audio signals, among the N input audio signals other than the first and second center input audio signals, to each of the first and second beginning divided audio signals, and generates a final mono audio signal by adding the first and second final divided audio signals; a side information generator that generates side information for restoring each of the N input audio signals, the first and second beginning divided audio signals, the first and second final divided audio signals, and transient divided audio signals, the transient divided audio signals generated from the remaining input audio signals; and an encoder that encodes the final mono audio signal and the side information.

The mono audio generator may include a plurality of down-mixers that each add two of audio signals among the N input audio signals, the first and second beginning divided audio signals, the transient mono audio signals, and the first and second final divided audio signals.

The apparatus may further include a difference information generator that encodes the N input audio signals, decodes the encoded N input audio signals, and generates information about differences between the N decoded input audio signals and the N received input audio signals, wherein the encoder may encode the information about the differences with the final mono audio signal and the side information.

According to another aspect of the present invention, there is provided an apparatus for decoding audio, the apparatus including: an extractor that extracts an encoded mono audio signal and encoded side information from received audio data; a decoder that decodes the extracted mono audio signal and the extracted side information; an audio restorer that restores first and second beginning restored audio signals from the decoded mono audio signal, generates N−2 final restored audio signals from transient restored audio signals by decoding the first and second beginning restored audio signals, generates, based on the decoded side information, a combination restored audio signal by adding the transient restored audio signals that are generated last from among the transient restored audio signals, and generates first and second final restored audio signals from the combination restored audio signal based on the decoded side information.

The audio restorer may include a plurality of up-mixers that generate first and second restored audio signals from audio signals of each of the decoded mono audio signal, the beginning restored audio signals, and the transient restored audio signals, based on the side information.

According to another aspect of the present invention, there is provided a computer readable recording medium having recorded thereon a program for executing a method of encoding audio, the method including: generating a first beginning divided audio signal and a second beginning divided audio signal from a beginning mono audio signal, the beginning mono audio signal generated from first and second center input audio signals located in the center of received N input audio signals; generating a first final divided audio signal and a second final divided audio signal by adding remaining input audio signals, among the N input audio signals other than the first and second center input audio signals, to each of the first and second beginning divided audio signals, and generating a final mono audio signal by adding the first and second final divided audio signals; generating side information for restoring each of the N input audio signals, the first and second beginning divided audio signals, the first and second final divided audio signals, and transient divided audio signals, the transient divided audio signals generated from the remaining input audio signals; and encoding the final mono audio signal and the side information.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating an apparatus for encoding audio, according to an exemplary embodiment of the present invention;

FIG. 2 is a diagram illustrating sub-bands in parametric audio coding;

FIG. 3A is a diagram for describing a method of generating information about intensities of a first center input audio signal and a second center input audio signal, according to an exemplary embodiment of the present invention;

FIG. 3B is a diagram for describing a method of generating information about intensities of the first center input audio signal and the second center input audio signal, according to another exemplary embodiment of the present invention;

FIG. 4 is a flowchart illustrating a method of encoding side information, according to an exemplary embodiment of the present invention;

FIG. 5 is a flowchart illustrating a method of encoding audio, according to an exemplary embodiment of the present invention;

FIG. 6 is a diagram illustrating an apparatus for decoding audio, according to an exemplary embodiment of the present invention;

FIG. 7 is a flowchart illustrating a method of decoding audio, according to an exemplary embodiment of the present invention;

FIG. 8 is a diagram illustrating an apparatus for encoding 5.1-channel stereo audio, according to an exemplary embodiment of the present invention;

FIG. 9 is a diagram illustrating an apparatus for decoding 5.1-channel stereo audio, according to an exemplary embodiment of the present invention; and

FIG. 10 is a diagram for describing an operation of an up-mixer, according to an exemplary embodiment of the present invention.

### DETAILED DESCRIPTION OF THE INVENTION

Hereinafter, the present invention will be described more fully with reference to the accompanying drawings, in which exemplary embodiments of the invention are shown.

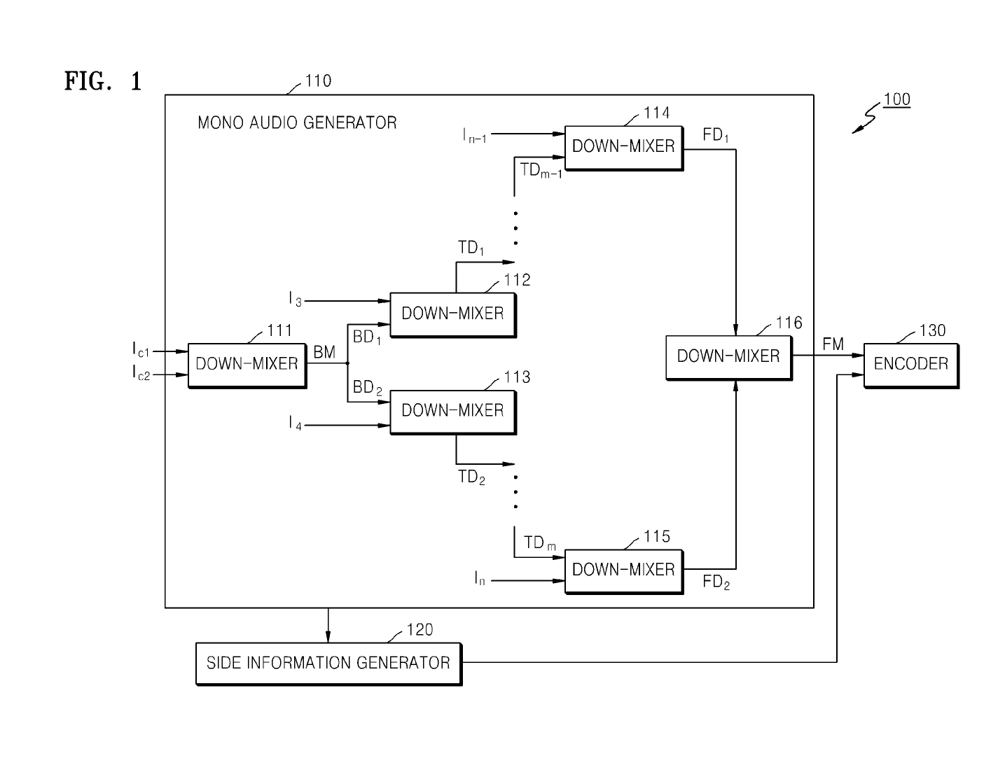

FIG. 1 is a diagram illustrating an apparatus for encoding audio, according to an exemplary embodiment of the present invention.

Referring to FIG. 1, the apparatus 100 includes a mono audio generator 110, a side information generator 120, and an encoder 130.

The mono audio generator 110 generates a first beginning divided audio signal BD₁ and a second beginning divided audio signal BD₂ from a beginning mono audio signal BM, which is generated by adding a first center input audio signal I_{c1} and a second center input audio signal I_{c2} that are located in the center of N received input audio signals I_{c1}, I_{c2}, and I₃ through Iₙ, wherein N and n are positive integers. The mono audio generator 110 also generates a first final divided audio signal FD₁ and a second final divided audio signal FD₂ by adding the remaining input audio signals I₃ through Iₙ to each of the first and second beginning divided audio signals BD₁ and BD₂ one by one in the order of adjacency to each of the first and second beginning divided audio signals BD₁ and BD₂. The mono audio generator 111 then generates a final mono audio signal FM by adding the first and second final divided audio signals FD₁ and FD₂.

Here, the mono audio generator 110 generates a first through m^{th} transient divided audio signals TD₁ through TDₘ while generating the final mono audio signal FM from the first and second beginning divided audio signals BD₁ and BD₂, wherein m is a positive integer.

Also, as illustrated in FIG. 1, the mono audio generator 110 includes a plurality of down-mixers 111-116 that add audio signals received from a combination of each of the input audio signals I_{c1}, I_{c2}, and I_{c} through Iₙ, the first and second beginning divided audio signals BD₁, BD₂, the first through m^{th} transient divided audio signals TD₁ through TDₘ, and the first and second final divided audio signals FD₁ and FD₂. The final mono audio signal FM is generated through the plurality of down-mixers.

For example, a down-mixer 111, which received the first and second center input audio signals I_{c1} and I_{c2}, generates the beginning mono audio signal BM by adding the first and second center input audio signals I_{c1} and I_{c2}. Here, the number of audio signals that are to be input to down-mixers 112, 113, which are downstream to down-mixer 111, is 3, i.e., an odd number (signals BM, I₃, and I₄). Thus, the down-mixer 111 that generated the beginning mono audio signal BM divides the beginning mono audio signal BM to generate the first beginning divided audio signal BD₁ and the second beginning divided audio signal BD₂. Accordingly, the number of audio signals that are to be input to down mixers 112 and 113 is four, and two audio signals are input to each of down-mixers 112, 113.

When the first and second beginning divided audio signals BD₁ and BD₂ are generated as described above, the down-mixer 112 that received the first beginning divided audio signal BD₁ generates the first transient divided audio signal TD₁ by adding the first beginning divided audio signal BD₁ and a third input audio signal I₃, i.e., an input audio signal that is most adjacent to the first center input audio signal I_{c1} from among the remaining input audio signals I₃ through Iₙ, and the down-mixer 113 that received the second beginning divided audio signal BD₂ generates the second transient divided audio signal TD₂ by adding the second beginning divided audio signal BD₂ and a fourth input audio signal I₄, i.e., an input audio signal that is most adjacent to the second center input audio signal I_{c2} from among the remaining input audio signals I₃ through Iₙ.

In other words, a down-mixer 112, 113 of the present invention receives an audio signal generated by a previous down-mixer 111 as one input, and receives one of the remaining input audio signals I₃ through Iₙ as another input, and adds the two inputs.

Here, the down-mixers 111-116 may adjust a phase of one of two audio signals to be identical to a phase of the other of the two audio signals before adding the two audio signals, instead of adding the two audio signals as they are received. For example, before adding the first and second center input audio signals I_{c1} and I_{c2}, a phase of the second center input audio signal I_{c2} may be adjusted to be identical to a phase of the first center input audio signal I_{c1}, thereby adding the phase-adjusted second center input audio signal I_{c2′} with the first center input audio signal I_{c1}. The details thereof will be described later.

Meanwhile, according to the current embodiment of the present invention, the N input audio signals I_{c1}, I_{c2}, and I₃ through Iₙ transmitted to the mono audio generator 110 are considered to be digital signals, but when the N input audio signals I_{c1}, I_{c2}, and I₃ through Iₙ are analog signals according to another embodiment of the present invention, the N analog input audio signals I_{c1}, I_{c2}, and I₃ through Iₙ may be converted to digital signals before being input to the mono audio generator 110, by performing sampling and quantization on the N input audio signals I_{c1}, I_{c2}, and I₃ through Iₙ.

The side information generator 120 generates side information required to restore each of the first and second center input audio signals I_{c1} and I_{c2}, the remaining input audio signals I₃ through Iₙ that are added one by one, the first and second beginning divided audio signals BD₁ and BD₂, the first through m^{th} transient divided audio signals TD₁ through TDₘ, and the first and second final divided audio signals FD₁ and FD₂.

Here, whenever the down-mixers 111-116 included in the mono audio generator 110 add audio signals, the side information generator 120 generates side information required to restore the added audio signals based on the result of adding the audio signals. Here, for convenience of description, the side information input from each down-mixer to the side information generator 120 is not illustrated in FIG. 1.

Here, the side information includes information for determining intensities of each of the first and second center input audio signals I_{c1} and I_{c2}, the remaining input audio signals I₃ through Iₙ that are added one by one, the first and second beginning divided audio signals BD₁ and BD₂, the first through m^{th} transient divided audio signals TD₁ through TDₘ, and the first and second final divided audio signals FD₁ and FD₂, and information about phase differences between the two added audio signals of the first and second center input audio signals I_{c1} and I_{c2}, the remaining input audio signals I₃ through Iₙ that are added one by one, the first and second beginning divided audio signals BD₁ and BD₂, the first through m^{th} transient divided audio signals TD₁ through TDₘ, and the first and second final divided audio signals FD₁ and FD₂.

According to another embodiment of the present invention, each down-mixer 111-116 may include the side information generator 120 in order to add the audio signals while generating the side information about the audio signals.

A method of generating the side information, wherein the method is performed by the side information generator 120, will be described in detail later with reference to FIGS. 2 through 4.

The encoder 130 encodes the final mono audio signal FM generated by the mono audio generator 110 and the side information generated by the side information generator 120.

Here, a method of encoding the final mono audio signal FM and the side information may be any general method used to encode mono audio and side information.

According to another exemplary embodiment of the present invention, the apparatus 100 may further include a difference information generator (not shown) which encodes the N input audio signals I_{c1}, I_{c2}, and I₃ through Iₙ, decodes the N encoded input audio signals I_{c1}, I_{c2}, and I₃ through Iₙ, and then generates information about differences between the N decoded input audio signals I_{c1}, I_{c2}, and I₃ through Iₙ and the N original input audio signals I_{c1}, I_{c2}, and I₃ through Iₙ.

As such, when the apparatus 100 includes the difference information generator, the encoder 130 may encode the information about differences along with the final mono audio signal FM and the side information. When the encoded mono audio signal generated by the apparatus 100 is decoded, the information about differences is added to the decoded mono audio signal, so that audio signals similar to the original N input audio signals I_{c1}, I_{c2}, and I₃ through Iₙ are generated.

According to another exemplary embodiment of the present invention, the apparatus 100 may further include a multiplexer (not shown), which generates a final bitstream by multiplexing the final mono audio signal FM and the side information that are encoded by the encoder 130.

A method of generating side information and a method of encoding the generated side information will now be described in detail. For convenience of description, the side information generated while the down-mixers 111-116 included in the mono audio generator 110 generate the beginning mono audio signal BM by receiving the first and second center input audio signals I_{c1} and I_{c2} will be described. Also, a case of generating information for determining intensities of the first and second center input audio signals I_{c1} and I_{c2}, and a case of generating information for determining phases of the first and second center input audio signals I_{c1} and I_{c2} will be described.

(1) Information for Determining Intensity

According to parametric audio coding, each channel audio signal is changed to a frequency domain, and information about the intensity and phase of each channel audio signal is encoded in the frequency domain, as will be described in detail with reference to FIG. 2.

FIG. 2 is a diagram illustrating sub-bands in parametric audio coding.

In detail, FIG. 2 illustrates a frequency spectrum in which an audio signal is converted to the frequency domain. When a fast Fourier transform is performed on the audio signal, the audio signal is expressed with discrete values in the frequency domain. In other words, the audio signal may be expressed as a sum of a plurality of sine curves.

In the parametric audio coding, when the audio signal is converted to the frequency domain, the frequency domain is divided into a plurality of sub-bands. Information for determining intensities of the first and second center input audio signals I_{c1} and I_{c2} and information for determining phases of the first and second center input audio signals I_{c1} and I_{c2} are encoded in each sub-band. Here, side information about intensity and phase in a sub-band k is encoded, and then side information about intensity and phase in a sub-band k+1 is encoded. As such, the entire frequency band is divided into sub-bands, and the side information is encoded according to each sub-band.

An example of encoding side information of the first and second center input audio signals I_{c1} and I_{c2} in a predetermined frequency band, i.e., in the sub-band k, will now be described in relation to encoding and decoding of stereo audio having input audio signals from N channels.

When side information about stereo audio is encoded according to conventional parametric audio coding, information about interchannel intensity difference (IID) and information about interchannel correlation (IC) is encoded as information for determining intensities of the first and second center input audio signals I_{c1} and I_{c2} in the sub-band k, as described above.

Here, in the sub-band k, the intensity of the first center input audio signal I_{c1} and the intensity of the second center input audio signal I_{c2} is calculated. A ratio of the intensity of the first center input audio signal I_{c1} to the intensity of the second center input audio signal I_{c2} is encoded as the information about IID. However, the ratio alone is not sufficient to determine the intensities of the first and second center input audio signals I_{c1} and I_{c2}, and thus the information about IC is encoded as side information, along with the ratio, and inserted into a bitstream.

A method of encoding audio, according to an exemplary embodiment of the present invention, uses a vector representing the intensity of the first center input audio signal I_{c1} in the sub-band k and a vector representing the intensity of the second center input audio signal I_{c2} in the sub-band k, in order to minimize the number of pieces of side information encoded as the information for determining the intensities of the first and second center input audio signals I_{c1} and I_{c2} in the sub-band k. Here, an average value of intensities in frequencies f₁ through fₙ in the frequency spectrum, in which the first center input audio signal I_{c1} is converted to the frequency domain, is the intensity of the first center input audio signal I_{c1} in the sub-band k, and also is a size of a vector I_{c1} that will be described later.

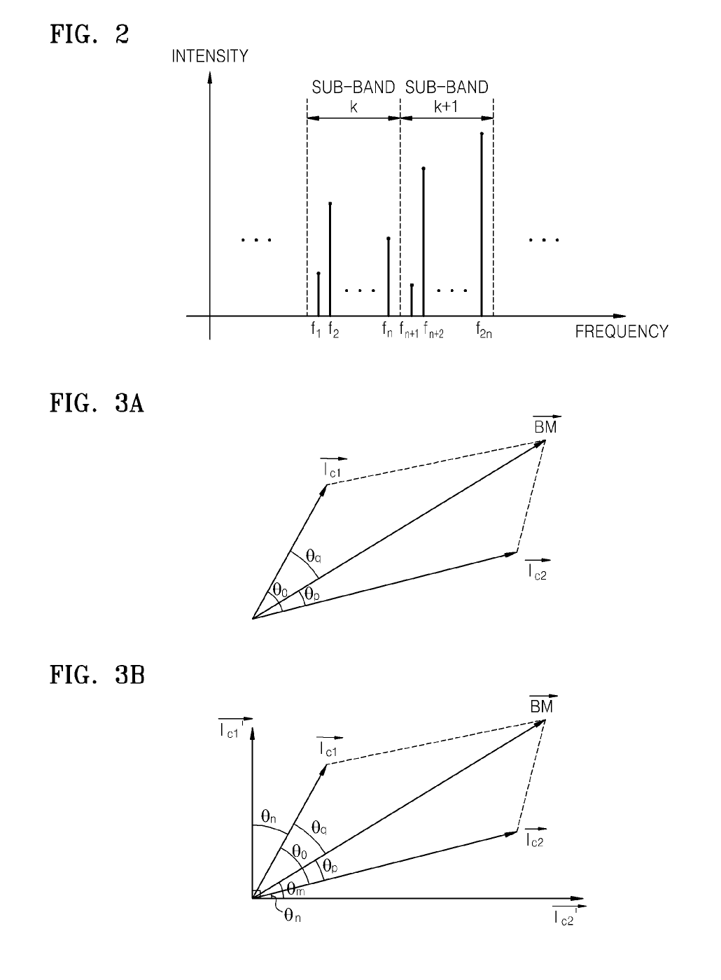

Similarly, an average value of intensities in frequencies f₁ through fₙ in the frequency spectrum, in which the second center input audio signal I_{c2} is converted to the frequency domain, is the intensity of the second center input audio signal I_{c2} in the sub-band k, and also is a size of a vector I_{c2}, as will be described in detail with reference to FIGS. 3A and 3B.

FIG. 3A is a diagram for describing a method of generating information about intensities of the first center input audio signal I_{c1} and the second center input audio signal I_{c2}, according to an exemplary embodiment of the present invention.

Referring to FIG. 3A, the side information generator 120 generates a 2-dimensional (2D) vector space in such a way that the I_{c1} vector, which is a vector about the intensity of the first center input audio signal I_{c1} in the sub-band k, and the I_{c2} vector, which is a vector about the intensity of the second center input audio signal I_{c2} in the sub-band k, form a predetermined angle θ₀. If the first and second center input audio signals I_{c1} and I_{c2} are respectively left audio and right audio, stereo audio is generally encoded assuming that a listener hears the stereo audio at a location where a left sound source direction and a right sound source direction form an angle of 60°. Accordingly, the predetermined angle θ₀ between the I_{c1} vector and the I_{c2} vector in the 2D vector space may be 60°. However, according to the current exemplary embodiment of the present invention, since the first and second center input audio signals I_{c1} and I_{c2} are not respectively left audio and right audio, the I_{c1} vector and the I_{c2} vector may have a predetermined angle θ₀.

In FIG. 3A, a BM vector, which is a vector about the intensity of the beginning mono audio signal BM and obtained by adding the I_{c1} vector and the I_{c2} vector, is illustrated. Here, as described above, if the first and second center input audio signals I_{c1} and I_{c2} respectively correspond to left audio and right audio, the listener, who listens to the stereo audio at the location where a left sound source direction and a right sound source direction form an angle of 60°, hears mono audio having an intensity corresponding to the size of the BM vector and in a direction of the BM vector.

The side information generator 120 generates information about an angle θ_{q} between the BM vector and the I_{c1} vector or an angle θₚ between the BM vector and the I_{c2} vector, instead of the information about IID and about IC, as the information for determining the intensities of the first and second center input audio signals I_{c1} and I_{c2} in the sub-band k.

Alternatively, instead of generating information about the angle θ_{q} or the angle θₚ, the side information generator 120 may generate a cosine value, such as cos θ_{q} or cos θₚ. This is because, a quantization process is performed when information about an angle is to be generated and encoded, and a cosine value of an angle is generated and encoded in order to minimize a loss occurring during the quantization process.

FIG. 3B is a diagram for describing a method of generating information about intensities of the first center input audio signal I_{c1} and the second center input audio signal I_{c2}, according to another exemplary embodiment of the present invention.

In detail, FIG. 3B illustrates a process of normalizing a vector angle in FIG. 3A.

As shown in FIG. 3B, when the angle θ₀ between the vector I_{c1} and the vector I_{c2} is not 90°, the angle θ₀ may be normalized to 90°, and at this time, the angle θₚ or θ_{q} is also normalized. When the angle θ₀ is normalized to 90°, the angle θₚ is normalized accordingly, and thus the angle θₘ=(θₚ×90)/θ₀. The side information generator 120 may generate an un-normalized angle θₚ or a normalized angle θₘ as the information for determining the intensities of the first and second center input audio signals I_{c1} and I_{c2}. Alternatively, the side information generator 120 may generate cos θₚ or cos θₘ, instead of the angle θₚ or θₘ, as the information for determining the intensities of the first and second center input audio signals I_{c1} and I_{c2}.

(2) Information for Determining Phase

In the conventional parametric audio coding, information about overall phase difference (OPD) and information about interchannel phase difference (IPD) is encoded as information for determining the phases of the first and second center input audio signals I_{c1} and I_{c2} in the sub-band k.

In other words, conventionally, the information about OPD is generated and encoded by calculating a phase difference between the first center input audio signal I_{c1} in the sub-band k and the beginning mono audio signal BM generated by adding the first center input audio signal I_{c1} and the second center input audio signal I_{c2} in the sub-band k. The information about IPD is generated and encoded by calculating a phase difference between the first center input audio signal I_{c1} and the second center input audio signal I_{c2} in the sub-band k. The phase difference may be obtained by calculating each of the phase differences at the frequencies f₁ through fₙ included in the sub-band and calculating the average of the calculated phase differences.

However, the side information generator 120 only generates information about a phase difference between the first and second center input audio signals I_{c1} and I_{c2} in the sub-band k, as information for determining the phases of the first and second center input audio signals I_{c1} and I_{c2}.

According to an exemplary embodiment of the present invention, the down-mixer 111-116 generates the phase-adjusted second center input audio signal I_{c2′} by adjusting the phase of the second center input audio signal I_{c2} to be identical to the phase of the first center input audio signal I_{c1}, and then adds the phase-adjusted second center input audio signal I_{c2′} with the first center input audio signal I_{c1}. Thus, the phases of the first and second center input audio signals I_{c1} and I_{c2} are each calculated only based on the information about the phase difference between the first and second center input audio signals I_{c1} and I_{c2}.

As an example of audio of the sub-band k, the phases of the second center input audio signal I_{c2} in the frequencies f₁ through fₙ are each respectively adjusted to be identical to the phases of the first center input audio signal I_{c1} in the frequencies f₁ through fₙ. An example of adjusting the phase of the second center input audio signal I_{c2} in the frequency f₁ will now be described. When the first center input audio signal I_{c1} is expressed as |I_{c1}|e^{i(2πf1t+θ}₁⁾ in the frequency f₁, and the second center input audio signal I_{c2} is expressed as |I_{c2}|e^{i(2πf1t+θ}₂⁾ in the frequency f₁, the phase-adjusted second center input audio signal I_{c2′} in the frequency f₁ may be obtained as Equation 1 below. Here, θ₁ denotes the phase of the first center input audio signal I_{c1} in the frequency f₁ and θ₂ denotes the phase of the second center input audio signal I_{c2} in the frequency f₁.

I_{c2′}=I_{c2}×e^{i(θ}₂^{-θ}₂⁾=|I_{c2}|e^{i(2πf1t+θ}₁⁾ Equation 1

According to Equation 1, the phase of the second center input audio signal I_{c2} in the frequency f₁ is adjusted to be identical to the phase of the first center input audio signal I_{c1}. The phases of the second center input audio signal I_{c2} are repeatedly adjusted in other frequencies f₂ through fₙ in the sub-band k, thereby generating the phase-adjusted second input audio signal I_{c2′} in the sub-band k.

Since the phase of the phase-adjusted second center input audio signal I_{c2′} is identical to the phase of the first center input audio signal I_{c1} in the sub-band k, a decoding unit for the beginning mono audio signal BM can obtain the phase of the second center input audio signal I_{c2} when only the phase difference between the first and second center input audio signals I_{c1} and I_{c2} is encoded. Since the phase of the first center input audio signal I_{c1} and the phase of the beginning mono audio signal BM generated by the down-mixer are the same, information about the phase of the first center input audio signal I_{c1} does not need to be separately encoded.

Accordingly, when only the information about the phase difference between the first and second center input audio signals I_{c1} and I_{c2} is encoded, the decoding unit can calculate the phases of the first and second center input audio signals I_{c1} and I_{c2} by using the encoded information.

Meanwhile, the method of encoding the information for determining the intensities of the first and second center input audio signals I_{c1} and I_{c2} by using intensity vectors of channel audio signals in the sub-band k, and the method of encoding the information for determining the phases of the first and second center input audio signals I_{c1} and I_{c2} in the sub-band k by adjusting the phases may be used independently or in combination. In other words, the information for determining the intensities of the first and second center input audio signals I_{c1} and I_{c2} is encoded by using a vector according to the present invention, and the information about OPD and IPD may be encoded as the information for determining the phases of the first and second center input audio signals I_{c1} and I_{c2} according to the conventional technology. Alternatively, the information about IID and IC may be encoded as the information for determining the intensities of the first and second center input audio signals I_{c1} and I_{c2} according to the conventional technology, and only the information for determining the phases of the first and second center input audio signals I_{c1} and I_{c2} may be encoded by using phase adjustment according to the present invention. Here, the side information may be encoded by using both methods according to the present invention.

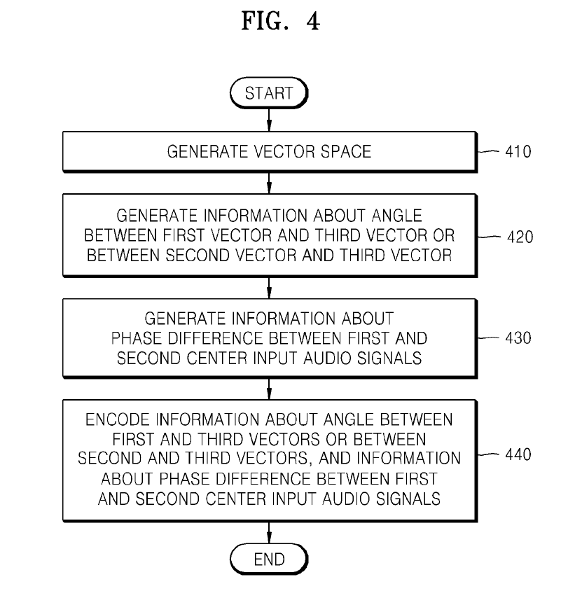

FIG. 4 is a flowchart illustrating a method of encoding side information, according to an exemplary embodiment of the present invention.

A method of encoding the information about the intensities and phases of the first and second center input audio signals I_{c1} and I_{c2} in a predetermined frequency band, i.e., in the sub-band k, will now be described with reference to FIG. 4.

In operation 410, the side information generator 120 generates a vector space in such a way that a first vector about the intensity of the first center input audio signal I_{c1} in the sub-band k and a second vector about the intensity of the second center input audio signal I_{c2} in the sub-band k form a predetermined angle.

Here, the side information generator 120 generates the vector space illustrated in FIG. 3A based on the intensities of the first and second center input audio signals I^{c1} and I_{c2} in the sub-band k.

In operation 420, the side information generator 120 generates information about an angle between the first vector and a third vector or between the second vector and the third vector, wherein the third vector represents the intensity of the beginning mono audio signal BM, which is generated by adding the first and second vectors in the vector space generated in operation 410.

Here, the information about the angle is the information for determining the intensities of the first and second center input audio signals I_{c1} and I_{c2} in the sub-band k. Also, the information about the angle may be information about a cosine value of the angle, instead of the angle itself.

Here, the beginning mono audio signal BM may be generated by adding the first and second center input audio signals I_{c1} and I_{c2}, or by adding the first center input audio signal I_{c1} and the phase-adjusted second center input audio signal I_{c2′}. Here, the phase of the phase-adjusted second center input audio signal I_{c2′} is identical to the phase of the first center input audio signal I_{c1} in the sub-band k.

In operation 430, the side information generator 120 generates the information about the phase difference between the first and second center input audio signals I_{c1} and I_{c2}.

In operation 440, the encoder 130 encodes the information about the angle between the first and third vectors or between the second and third vectors, and the information about the phase difference between the first and second center input audio signals I_{c1} and I_{c2}.

The method of generating and encoding side information described above with reference to FIGS. 2 through 4 may be identically applied to generate side information for restoring audio signals that are added in each of the N input audio signals I_{c1}, I_{c2}, and I_{c} through Iₙ, the first and second beginning divided audio signals BD₁ and BD₂, the first through m^{th} transient divided audio signals TD₁ through TDₘ, and the first and second final divided audio signals FD₁ and FD₂ illustrated in FIG. 1.

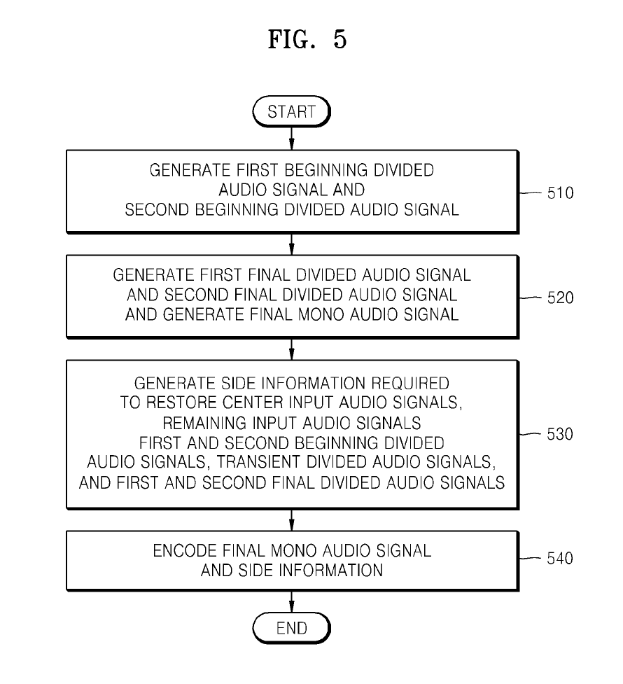

FIG. 5 is a flowchart illustrating a method of encoding audio, according to an exemplary embodiment of the present invention.

In operation 510, the first beginning divided audio signal BD₁ and the second beginning divided audio signal BD₂ are generated by dividing one beginning mono audio signal BM, which is generated by adding the first and second center input audio signals I_{c1} and I_{c2} that are located in the center from among the N received input audio signals I_{c1}, I_{c2}, and I₃ through Iₙ, where N and n are positive integers.

In operation 520, the first final divided audio signal FD₁ and the second final divided audio signal FD₂ are generated by adding the remaining input audio signals I₃ through Iₙ to each of the first and second beginning divided audio signals BD₁ and BD₂ one by one in the order of adjacency to the each of the first and second beginning divided audio signals BD₁ and BD₂. The final mono audio signal FM is generated by adding the first and second final divided audio signals FD₁ and FD₂.

In operation 530, side information required to restore each of the first and second center input audio signals I_{c1} and I_{c2}, the remaining input audio signals I₃ through Iₙ that are added one by one, the first and second beginning divided audio signals BD₁ and BD₂, the first through m^{th} transient divided audio signals TD₁ through TDₘ, and the first and second final divided audio signals FD₁ and FD₂ is generated.

Here, the remaining input audio signals I₃ through Iₙ are the N input audio signals I_{c1}, I_{c2}, and I₃ through Iₙ excluding the first and second center input audio signals I_{c1} and I_{c2}.

In operation 540, the final mono audio signal FM and the side information are encoded.

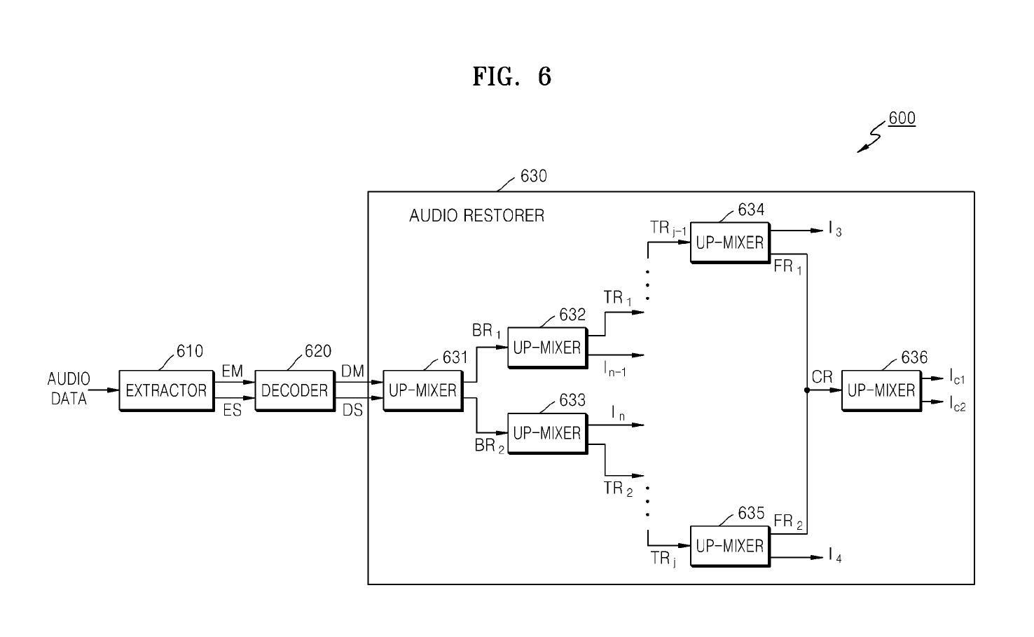

FIG. 6 is a diagram illustrating an apparatus for decoding audio, according to an exemplary embodiment of the present invention.

Referring to FIG. 6, the apparatus 600 includes an extractor 610, a decoder 620, and an audio restorer 630.

The extractor 610 extracts an encoded mono audio signal EM and encoded side information ES from received audio data. Here, the extractor 610 may also be called a demultiplexer.

According to another exemplary embodiment of the present invention, the encoded mono audio signal EM and the encoded side information ES may be received instead of the audio data, and in this case, the extractor 610 may not be included in the apparatus 600.

The decoder 620 decodes the encoded mono audio signal EM and the encoded side information ES extracted by the extractor 610 to produce decoded side information DS and a decoded mono audio signal DM, respectively.

The audio restorer 630 restores first and second beginning restored audio signals BR₁ and BR₂ from the decoded mono audio signal DM, generates N−2 final restored audio signals I₃ through Iₙ by sequentially generating one final restored audio signal FR and one transient restored audio signal TR, by consecutively applying the same decoding method used to decode the extracted mono audio signal EM and the extracted side information ES, a plurality of times on each of the first and second beginning restored audio signals BR₁ and BR₂. The audio restorer 630 generates a combination restored audio signal CR by adding two final transient restored audio signals FR₁ and FR₂ that are generated last from among the generated transient restored audio signals TR₁ through TRⱼ, and then generates two final restored audio signals I_{c1} and I_{c2} additionally from the combination restored audio signal CR, based on the decoded side information DS, where j is a positive integer.

Also, as illustrated in FIG. 6, the audio restorer 630 includes a plurality of up-mixers 631-636, which generate restored audio signals from each one of the beginning restored audio signals BR₁ and BR₂, and the transient restored audio signals TR₁ through TRⱼ. The audio restorer 630 generates the final restored audio signals I_{c1}, I_{c2}, and I_{c} through Iₙ with the plurality of up-mixers 631-636.

In FIG. 6, the decoded side information DS is transmitted to the up-mixers 631-636 included in the audio restorer 630 through the decoder 620, but for convenience of description, the decoded side information DS transmitted to each of the up-mixers 631-636 is not illustrated.

Meanwhile, according to another exemplary embodiment of the present invention, if the extractor 610 further extracts information about differences between N decoded audio signals, which are generated by encoding and decoding N original audio signals that are to be restored from the audio data through the N final restored audio signals I_{c1}, I_{c2}, and I_{c} through Iₙ, and the N original audio signals, the information about the differences is decoded by using the decoder 620. The decoded information about the differences may be added to each of the final restored audio signals I_{c1}, I_{c2}, and I_{c} through Iₙ generated by the audio restorer 630. Accordingly, the final restored audio signals I_{c1}, I_{c2}, and I_{c} through Iₙ are similar to the N original audio signals.

Operations of an up-mixer 636 will now be described in detail. Here, for convenience of description, the up-mixer 636 receives the combination restored audio signal CR and restores the first and second center input audio signals I_{c1} and I_{c2} as final restored audio signals.

Referring to the vector space illustrated in FIG. 3A, the up-mixer 636 uses information about an angle between a BM vector and a I_{c1} vector or between the BM vector and a I_{c2} vector as information for determining intensities of the first and second center input audio signals I_{c1} and I_{c2} in the sub-band k, wherein the BM vector represents the intensity of the combination restored audio signal CR, the vector I_{c1} represents the intensity of the first center input audio signal I_{c1}, and the vector I_{c2} represents the intensity of the second center input audio signal I_{c2}. The up-mixer 636 may use information about a cosine value of the angle between the BM vector and the I_{c1} vector or between the BM vector and the I_{c2} vector.

Referring to FIG. 3B, when an angle θ₀ between the vector I_{c1} and the vector I_{c2} is 60°, the size of the intensity of the first center input audio signal I_{c1}, i.e., the size of the vector I_{c1}, may be calculated according to |I_{c1}|=|BM|×sin θₘ/cos(π/12). Similarly, when an angle θ₀ between the vector I_{c1} and the vector I_{c2} is 60°, the size of the intensity of the second center input audio signal I_{c2}, i.e., the size of the vector I^{c2}, may be calculated according to |Ic2|=|BM|×cos θ^{m}/cos(π/12). Here, |BM| denotes the size of the intensity of the combination restored audio signal CR, i.e., the size of the BM vector, an angle between the vector I_{c1} and a vector I_{c1′} is 15°, and an angle between the vector I_{c2} and a vector I_{c2′} is 15°.

Also, the up-mixer 636 may use information about a phase difference between the first and second center input audio signals I_{c1} and I_{c2} as information for determining phases of the first and second center input audio signals I_{c1} and I_{c2} in the sub-band k. When the phase of the second center input audio signal I_{c2} is already adjusted to be identical to the phase of the first center input audio signal I_{c1} while encoding the combination restored audio signal CR, the up-mixer 636 may calculate the phases of the first and second center input audio signals I_{c1} and I_{c2} by using only the information about the phase difference between the first and second center input audio signals I_{c1} and I_{c2}.

Meanwhile, the method of decoding the information for determining the intensities of the first and second center input audio signals I_{c1} and I_{c2} in the sub-band k by using a vector, and the method of decoding the information for determining the phases of the first and second center input audio signals I_{c1} and I_{c2} in the sub-band k by using phase adjustment as described above may be used independently or in combination.

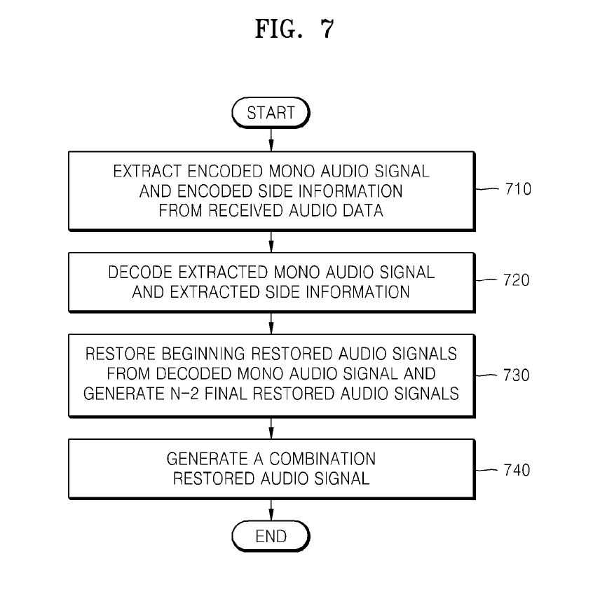

FIG. 7 is a flowchart illustrating a method of decoding audio, according to an exemplary embodiment of the present invention.

In operation 710, an encoded mono audio signal EM and encoded side information ES are extracted from received audio data.

In operation 720, the extracted mono audio signal EM and the extracted side information ES are decoded.

In operation 730, two beginning restored audio signals BR₁ and BR₂ are restored from the decoded mono audio signal DM based on the decoded side information DS, and N−2 final restored audio signals I₃ through Iₙ are generated by sequentially generating one final restored audio signal and one transient restored audio signal by consecutively applying the same decoding method a plurality of times on each of the beginning restored audio signals BR₁ and BR₂.

In operation 740, a combination restored audio signal CR is generated by adding final transient restored audio signals FR₁ and FR₂ that are generated the last from among the generated transient restored audio signals TR₁ through TRⱼ, and then two final restored audio signals I_{c1} and I_{c2} are generated from the combination restored audio signal CR based on the decoded side information DS.

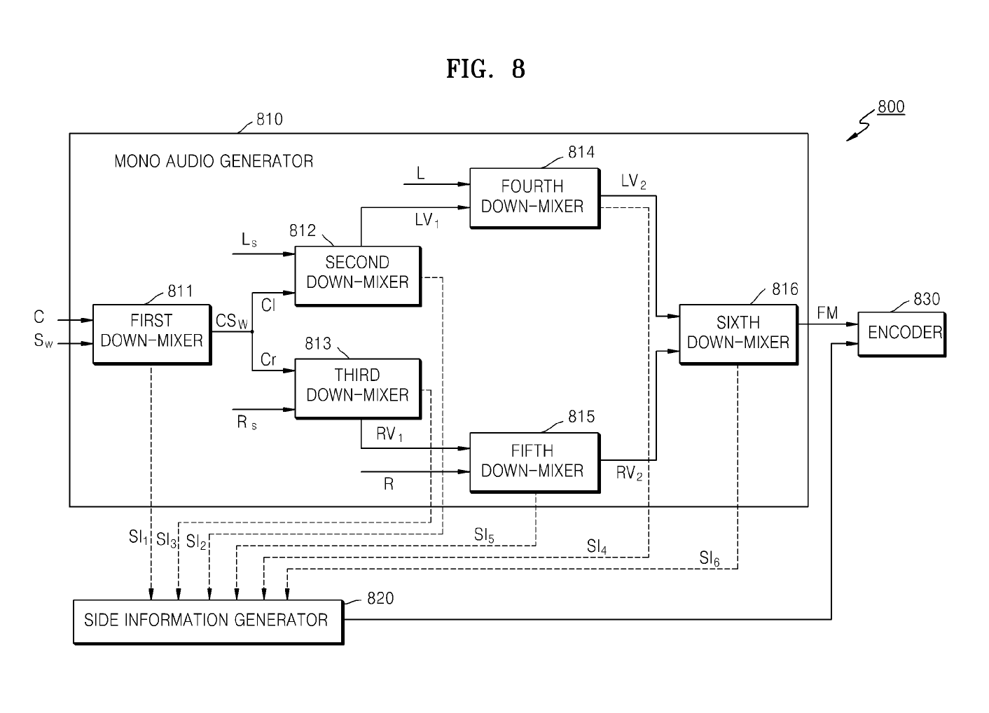

FIG. 8 is a diagram illustrating an apparatus for encoding 5.1-channel stereo audio, according to an exemplary embodiment of the present invention.

Referring to FIG. 8, the apparatus 800 includes a mono audio generator 810, a side information generator 820, and an encoder 830. Audio signals input to the apparatus 800 include a left channel front audio signal L, a left channel rear audio signal Lₛ, central audio signal C, a sub-woofer audio signal S_{w}, a right channel front audio signal R, and right channel rear audio signal Rₛ. Here, the central audio signal C and the sub-woofer audio signal S_{w} respectively correspond to the first center input audio signal I_{c1} and the second center input audio signal I_{c2}.

Operations of the mono audio generator 810 will now be described.

The mono audio generator 810 includes a plurality of down-mixers 811-816. A first down-mixer 811 generates a signal CS_{w} by adding the central audio signal C and the sub-woofer audio signal S_{w}. Then, the first down-mixer 811 divides the signal CS_{w} into signals Cl and Cr, which are respectively input to a second down-mixer 812 and a third down-mixer 813. Here, the signals Cl and Cr each have a size obtained by multiplying signal CS_{w} by 0.5, but the sizes of the signals Cl and Cr are not limited thereto and any value may be used for the multiplication.

Here, first through sixth down-mixers 811 through 816 may adjust phases of two audio signals to be identical before adding the two audio signals.

The second down-mixer 812 generates signal LV₁ by adding the signal Cl and the left channel rear audio signal Lₛ, and the third down-mixer 813 generates signal RV₁ by adding the signal Cr and the right channel rear audio signal Rₛ.

The fourth down-mixer 814 generates signal LV₂ by adding the signal LV₁ and the left channel front audio signal L, and the fifth down-mixer 815 generates signal RV₂ by adding the signal RV₁ and the right channel front audio signal R.

The sixth down-mixer 816 generates a final mono audio FM by adding the signals LV₂ and RV₂.

Here, the signals Cl and Cr respectively correspond to the first and second beginning divided audio signals BD₁, BD₂, the signals LV₁ and the RV₁ respectively correspond to the transient divided audio signals TD₁ through TDj, the signals LV₂ and RV₂ respectively correspond to the first and second final divided audio signals FD₁ and FD₂, and the signals Lₛ, L, Rₛ, and R respectively correspond to the remaining input audio signals I₃ through Iₙ.

A side information generator 820 receives side information SI₁ through SI₆ from the first through sixth down-mixers 811 through 816, or reads the side information SI₁ through SI₆ from the first through sixth down-mixers 811 through 816 and outputs the side information SI₁ through SI₆ to the encoder 830. Here, dotted lines in FIG. 8 indicate that the side information SI₁ through SI₆ is transmitted from the first through sixth down-mixers 811 through 816 to the side information generator 820.

The encoder 830 encodes the final mono audio signal FM and the side information SI₁ through SI₆.

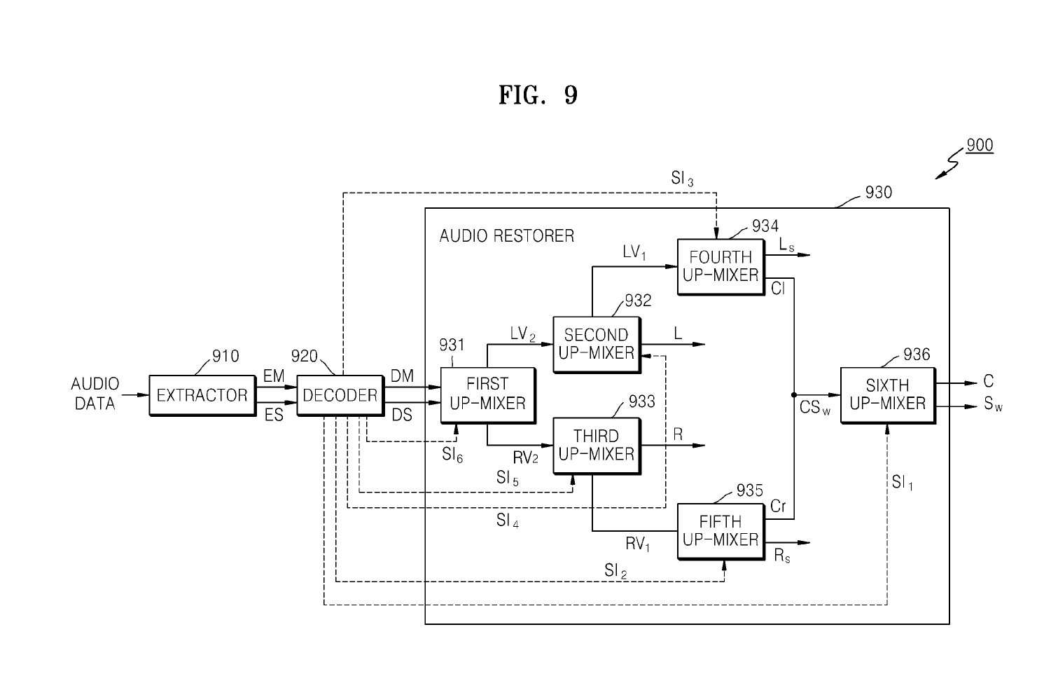

FIG. 9 is a diagram illustrating an apparatus for decoding 5.1-channel stereo audio, according to an exemplary embodiment of the present invention.

The apparatus 900 includes an extractor 910, a decoder 920, and an audio restorer 930. The operations of the extractor 910 and the decoder 920 of FIG. 9 are respectively similar to those of the extractor 610 and the decoder 620 of FIG. 6, and thus details thereof are omitted herein. The operations of the audio restorer 930 will now be described in detail.

The audio restorer 930 includes a plurality of up-mixers 931-936. A first up-mixer 931 restores signals LV₂ and RV₂ from a decoded mono audio signal DM.

Here, first through sixth up-mixers 931 through 936 perform restoration based on decoded side information SI₁ through SI₆ received from the decoder 920.

The second up-mixer 932 restores signals LV₁ and L from the signal LV₂, and the third up-mixer 933 restores signals RV₁ and R from the signal RV₂.

The fourth up-mixer 934 restores signals Lₛ and Cl from the signal LV₁, and the fifth up-mixer 935 restores signals Rₛ and Cr from signal RV₁.

The sixth up-mixer 936 generates signal CS_{w} from signals Cl and Cr, and then restores C and S_{w} from the signal CS_{w}.

Looking at the operations of the first through sixth up-mixers 931 through 936, the second through fifth up-mixers 932 through 935, excluding the first and sixth up-mixers 931 and 936, generate one transient restored audio signal and one final restored audio signal.

Here, the signals LV₂ and RV₂ respectively correspond to the first and second beginning restored audio signals BR₁ and BR₂, the signals LV₁ and RV₁ correspond to the transient restored audio signals TR, the signals Cl and CR respectively correspond to the final transient restored audio signals FR₁ and FR₂, and the signal CS_{w} corresponds to the combination restored audio signal CR.

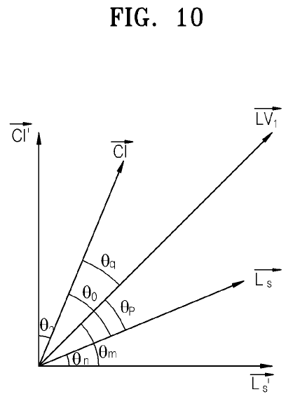

A method of restoring audio signals performed by the first through sixth up-mixers 931 through 936 will now be described in detail. Specifically, the operations of the fourth up-mixer 934 will be described with reference to FIG. 10.

FIG. 10 is a diagram for describing the operations of the fourth up-mixer 934, according to an exemplary embodiment of the present invention.

Various methods of restoring the final transient restored audio signal Cl and the left channel rear audio signal Lₛ will now be described.

A first method is to restore the final transient restored audio signal Cl and the left channel rear audio signal Lₛ by using an angle θₘ, obtained by normalizing an angle θₚ between the LV₁ vector and the Lₛ vector as described above. Referring to FIG. 3B, when an angle θ₀ is normalized to 90°, the angle θₚ is also normalized, and thus the angle θₘ=(θₚ×90)/θ₀. As such, when the angle θₘ is calculated, the size of the vector Cl is calculated according to |LV₁|sin θₘ/cos θₙ and the size of the vector Lₛ is calculated according to |LV₁|cos θₘ/cos θₙ, thereby determining the intensities of the final transient restored audio signal Cl and the left channel rear audio signal Lₛ. Then, the phases of the final transient restored audio signal Cl and the left channel rear audio signal Lₛ are calculated based on side information. Thus, the final transient restored audio signal Cl and the left channel rear audio signal Lₛ are restored.

In a second method, when the final transient restored audio signal Cl or the left channel rear audio signal Lₛ are restored according to the first method, the final transient restored audio signal Cl is restored by subtracting the left channel rear audio signal Lₛ from the transient mono audio signal LV₁, and the left channel rear audio signal Lₛ is restored by subtracting the final transient restored audio signal Cl from the transient mono audio signal LV₁.

A third method is to restore audio signals by combining audio signals restored according to the first method and audio signals restored according to the second method in a predetermined ratio.

In other words, when the final transient restored audio signal Cl and the left channel rear audio signal Lₛ restored according to the first method are respectively referred to as Cl_{y} and L_{sy}, and the final transient restored audio signal Cl and the left channel rear audio signal Lₛ restored according to the second method are respectively referred to as Cl_{z} and L_{sz}, the intensities of the final transient restored audio signal Cl and the left channel rear audio signal Lₛ are respectively determined according to |Cl|=a×|Cl_{y}|+(1−a)×|Cl_{z}| and |Lₛ|=a×|L_{sy}|+(1−a)×|L_{sz}|. The phases of the final transient restored audio signal Cl and the left channel rear audio signal Lₛ are calculated based on side information, thereby restoring the final transient restored audio signal Cl and the left channel rear audio signal Lₛ. Here, “a” is a value between 0 and 1.

According to another exemplary embodiment of the present invention, when the final restored audio signal Cl is restored by the fourth up-mixer 934 according to the above methods, the signal Rₛ output from the fifth up-mixer 935 may be restored without using separate side information. In other words, the final restored audio signal Cl and Cᵣ are audio signals divided from the signal CS_{w}, and thus the intensities and the phases of the final restored audio signal Cl and Cᵣ are the same. Accordingly, the fifth up-mixer 935 may restore the vector Rₛ by subtracting the vector Cl from the vector RV₁.

When such a method is applied to FIG. 6, and an up-mixer restores the final transient restored audio signals FR from a j−1^{th} transient restored audio TRⱼ₋₁, a vector I₄ may be restored by subtracting a j^{th} transient restored audio TRⱼ from the restored final transient restored audio signal FR₁.

The embodiments of the present invention may be written as computer programs and can be implemented in general-use digital computers that execute the programs using a computer readable recording medium. Examples of the computer readable recording medium may include magnetic storage media (e.g., ROM, floppy disks, hard disks, etc.), optical recording media (e.g., CD-ROMs, or DVDs), and storage media.

While this invention has been particularly shown and described with reference to preferred embodiments thereof, it will be understood by those of ordinary skill in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of encoding audio, the method comprising:
generating a first beginning divided audio signal and a second beginning divided audio signal from a beginning mono audio signal, the beginning mono audio signal generated from first and second center input audio signals located in the center of received N input audio signals;
generating a first final divided audio signal and a second final divided audio signal by adding remaining input audio signals, among the N input audio signals other than the first and second center input audio signals, to each of the first and second beginning divided audio signals, and generating a final mono audio signal by adding the first and second final divided audio signals;
generating side information for restoring each of the N input audio signals, the first and second beginning divided audio signals, the first and second final divided audio signals, and transient divided audio signals, the transient divided audio signals generated from the remaining input audio signals; and
encoding the final mono audio signal and the side information.

2. The method of claim 1, further comprising:
encoding the N input audio signals;
decoding the encoded N input audio signals; and
generating information about differences between the decoded N input audio signals and the received N input audio signals,
wherein, in the encoding of the final mono audio signal and the side information, the information about the differences is encoded.

3. The method of claim 1, wherein the encoding of the side information comprises:
encoding information for determining intensities of the first and second center input audio signals, the remaining input audio signals, the first and second beginning divided audio signals, the transient divided audio signals, and the first and second final divided audio signals; and
encoding information about phase differences between the first and second center input audio signals in the first and second center input audio signals, the remaining input audio signals, the first and second beginning divided audio signals, the transient divided audio signals, and the first and second final divided audio signals.

4. The method of claim 3, wherein the encoding of the information for determining intensities comprises:
generating a vector space in which a first vector and a second vector form a predetermined angle, wherein the first vector represents an intensity of the first center input audio signal, and the second vector represents an intensity of the second center input audio signal;
generating a third vector by adding the first vector and the second vector in the vector space; and
encoding at least one of information about an angle between the third vector and the first vector, and information about an angle between the third vector and the second vector, in the vector space.

5. The method of claim 3, wherein the encoding of the information for determining intensities comprises encoding at least one of information for determining an intensity of the first beginning divided audio signal and information for determining an intensity of the second beginning divided audio signal.

6. A method of decoding audio, the method comprising:
extracting an encoded mono audio signal and encoded side information from received audio data;
decoding the extracted mono audio signal and the extracted side information;
restoring first and second beginning restored audio signals from the decoded mono audio signal, and generating N−2 final restored audio signals from transient restored audio signals by decoding the first and second beginning restored audio signals, based on the decoded side information; and
generating a combination restored audio signal by adding the transient restored audio signals that are generated last from among the transient restored audio signals, and generating first and second final restored audio signals from the combination restored audio signal based on the decoded side information.

7. The method of claim 6, further comprising extracting information about differences between N decoded audio signals and N original audio signals in the received audio data, wherein the N decoded audio signals are generated by encoding and decoding the N original audio signals,
wherein the first and second final restored audio signals are generated based on the decoded side information and the information about the differences.

8. The method of claim 6, wherein the decoded side information comprises:
information for determining intensities of the first and second beginning restored audio signals, the transient restored audio signals, and the first and second final restored audio signals; and
information about phase differences between the first and second final restored audio signals restored from the first and second beginning restored audio signals, the transient restored audio signals, and the first and second final restored audio signals.

9. The method of claim 8, wherein the information for determining the intensities comprises information about an angle between a first vector and a third vector or between a second vector and the third vector in a vector space generated in such a way that the first vector and the second vector form a predetermined angle, wherein the first vector is about intensity of one of two following restored audio signals of each of the beginning restored audio signals, the transient restored audio signals, and the final restored audio signals, the second vector is about intensity of the other of the two following restored audio signals, and the third vector is generated by adding the first and second vectors.

10. The method of claim 9, wherein the restoring of the first and second beginning restored audio signals comprises:
determining an intensity of at least one of the first beginning restored audio signal and the second beginning restored audio signal, by using at least one of the angle between the first vector and the third vector and the angle between the second vector and the third vector;
calculating a phase of the first beginning restored audio signal and a phase of the second beginning restored audio signal based on information about a phase of the decoded mono audio signal and information about a phase difference between the first beginning restored audio signal and the second beginning restored audio signal; and
restoring the first and second beginning restored audio signals based on the information about the phase of the decoded mono audio signal, the information about the phase of the second beginning restored audio signal, and the information for determining the intensities of the first and second beginning restored audio signals.

11. The method of claim 9, wherein, when a first final transient restored audio signal from among the final transient restored audio signals and the first final restored audio signal are restored from a J−1^{th} transient restored audio signal, and the second final restored audio signal and a second final transient restored audio signal having an intensity that is the same as an intensity and a phase that is the same phase as the first final transient restored audio signal is restored from a J^{th} transient restored audio signal, and
wherein the second final restored audio signal is restored by subtracting the first final transient restored audio signal from the J^{th} transient restored audio signal, when the first final transient restored audio signal is restored based on information about a phase of the J−1^{th} transient restored audio signal, the information about a phase difference between the first final restored audio signal and the first final transient restored audio signal, and information for determining the intensity of the first final transient restored audio signal.

12. An apparatus for encoding audio, the apparatus comprising:
a mono audio generator that generates a first beginning divided audio signal and a second beginning divided audio signal from a beginning mono audio signal, the beginning mono audio signal generated from first and second center input audio signals located in the center of received N input audio signals, generates a first final divided audio signal and a second final divided audio signal by adding remaining input audio signals, among the N input audio signals other than the first and second center input audio signals, to each of the first and second beginning divided audio signals, and generates a final mono audio signal by adding the first and second final divided audio signals;
a side information generator that generates side information for restoring each of the N input audio signals, the first and second beginning divided audio signals, the first and second final divided audio signals, and transient divided audio signals, the transient divided audio signals generated from the remaining input audio signals; and
an encoder that encodes the final mono audio signal and the side information.

13. The apparatus of claim 12, wherein the mono audio generator comprises a plurality of down-mixers that each add two of audio signals among the N input audio signals, the first and second beginning divided audio signals, the transient mono audio signals, and the first and second final divided audio signals.

14. The apparatus of claim 12, further comprising a difference information generator that encodes the N input audio, decodes the encoded N input audio signals, and generates information about differences between the N decoded input audio signals and the N received input audio signals,
wherein the encoder encodes the information about the differences with the final mono audio signal and the side information.

15. The apparatus of claim 12, wherein the encoder encodes information for determining intensities of the first and second center input audio signals, the remaining input audio signals, the first and second beginning divided audio signals, the transient divided audio signals, and the first and second final divided audio signals, and encodes information about phase differences between the first and second audio signals in the first and second center input audio signals, the remaining input audio signals, the first and second beginning divided audio signals, the transient divided audio signals, and the first and second final divided audio signals.

16. The apparatus of claim 14, wherein the encoder generates a vector space in which a first vector and a second vector form a predetermined angle, wherein the first vector represents an intensity of the first center input audio signal, and the second vector represents an intensity of the second center input audio signal, generates a third vector by adding the first vector and the second vector in the vector space; and encodes at least one of information about an angle between the third vector and the first vector and information about an angle between the third vector and the second vector, in the vector space.

17. The apparatus of claim 14, wherein the encoder encodes at least one of information for determining an intensity of the first beginning divided audio signal and information for determining an intensity of the second beginning divided audio signal.

18. An apparatus for decoding audio, the apparatus comprising:
an extractor that extracts an encoded mono audio signal and encoded side information from received audio data;
a decoder that decodes the extracted mono audio signal and the extracted side information;
an audio restorer that restores first and second beginning restored audio signals from the decoded mono audio signal, generates N−2 final restored audio signals from transient restored audio signals by decoding the first and second beginning restored audio signals, generates, based on the decoded side information, a combination restored audio signal by adding the transient restored audio signals that are generated last from among the transient restored audio signals, and generates first and second final restored audio signals from the combination restored audio signal based on the decoded side information.

19. The apparatus of claim 18, wherein the audio restorer comprises a plurality of up-mixers that generate first and second restored audio signals from audio signals of each of the decoded mono audio signal, the beginning restored audio signals, and the transient restored audio signals, based on the side information.

20. The apparatus of claim 18, wherein the extractor extracts information about differences between N decoded audio signals and N original audio signals in the received audio data, wherein the N decoded audio signals are generated by encoding and decoding the N original audio signals,
wherein the first and second final restored audio signals are generated based on the decoded side information and the information about the differences.

21. The apparatus of claim 18, wherein the decoded side information comprises:
information for determining intensities of the first and second beginning restored audio signals, the transient restored audio signals, and the first and second final restored audio signals; and
information about phase differences between the first and second final restored audio signals restored from the first and second beginning restored audio signals, the transient restored audio signals, and the first and second final restored audio signals.

22. The apparatus of claim 21, wherein the information for determining the intensities comprises information about an angle between a first vector and a third vector or between a second vector and the third vector in a vector space generated in such a way that the first vector and the second vector form a predetermined angle, wherein the first vector is about intensity of one of two following restored audio signals of each of the beginning restored audio signals, the transient restored audio signals, and the final restored audio signals, the second vector is about intensity of the other of the two following restored audio signals, and the third vector is generated by adding the first and second vectors.

23. The apparatus of claim 22, wherein the audio restorer determines intensity of at least one of the first beginning restored audio signal and the second beginning restored audio signal, by using at least one of the angle between the first vector and the third vector and the angle between the second vector and the third vector, calculates a phase of the first beginning restored audio signal and a phase of the second beginning restored audio signal based on information about a phase of the decoded mono audio signal and information about a phase difference between the first beginning restored audio signal and the second beginning restored audio signal, and restores the first and second beginning restored audio signals based on the information about the phase of the decoded mono audio signal, the information about the phase of the second beginning restored audio signal, and the information for determining the intensities of the first and second beginning restored audio signals.

24. The apparatus of claim 22, wherein the audio restorer restores the first final restored audio signal and a first final transient restored audio signal from among the final transient restored audio signals from a J−1^{th} transient restored audio signal among the transient restored audio signals, and restores the second final restored audio signal and a second final transient restored audio signal having an intensity that is the same as an intensity and a phase that is the same phase as the first final transient restored audio signal from a J^{th} transient restored audio signal,
restores the first final transient restored audio signal based on the information about the phase of the J−1^{th} transient restored audio signal, information about a phase difference between the first final restored audio signal and the first final transient restored audio signal, and information for determining the intensity of the first final transient restored audio signal, and
restores the second final restored audio signal by subtracting the first final transient restored audio signal from the J^{th} transient restored audio signal.

25. A computer readable recording medium having recorded thereon a program for executing the method of claim 1.
